(19) United States
(12) Patent Application Publication
(10) Pub. No.: US 2018/0201132 A1
(43) Pub. Date: Jul. 19, 2018

(54) MOBILE MACHINE-USER PROTOCOL SYSTEM AND METHOD

(71) Applicant: Deere & Company, Moline, IL (US)

(72) Inventor: Mark J. Cherney, Potosi, WI (US)

(21) Appl. No.: 15/405,702

(22) Filed: Jan. 13, 2017

(51) Int. Cl. B60K 28/06; H04B 1/3827; H04W 4/02; B60T 7/14; B60T 7/16; B60W 40/08

(52) U.S. Cl. CPC B60K 28/066; H04B 1/385; H04W 4/025; H04M 1/72533; B60T 7/16; B60W 40/08; B60T 7/14

(57) ABSTRACT

A mobile machine-user protocol system includes a communication component device configured to receive user characteristic data with at least one user characteristic collected by a portable device positioned on a user; and a protocol controller coupled to the communication component device and storing at least one machine-user rule having a first threshold. The protocol controller includes a portable device interface module configured to extract the at least one user characteristic from the user characteristic data; and a rules module configured to evaluate the at least one user characteristic in view of the at least one machine-user rule to determine when the at least one user characteristic meets the first threshold and to generate a machine command for the work machine when the at least one user characteristic meets the first threshold.

### CROSS-REFERENCE TO RELATED APPLICATION(S)

Not applicable.

### STATEMENT OF FEDERALLY SPONSORED RESEARCH OR DEVELOPMENT

Not applicable.

### FIELD OF THE DISCLOSURE

This disclosure relates to work machines and to operating work machines.

### BACKGROUND OF THE DISCLOSURE

In the construction, agriculture, mining, and forestry industries, many different types of work machines are operated to perform various tasks at work sites. As examples, a dump truck may be utilized to haul loads of material over rough terrain or a yarder may be utilized to pull a harvested tree to a landing site. Worker safety is always important, particularly at busy work sites with large machines, and it is continuously desirable to provide systems and methods to improve worker safety relative to work machines.

### SUMMARY OF THE DISCLOSURE

The disclosure provides a system and method for operating a work machine according to a machine-user protocol.

In one aspect the disclosure provides a mobile machine-user protocol system. The system includes a communication component device configured to receive user characteristic data with at least one user characteristic collected by a portable device positioned on a user; and a protocol controller coupled to the communication component device and storing at least one machine-user rule having a first threshold. The protocol controller includes a portable device interface module configured to extract the at least one user characteristic from the user characteristic data; and a rules module configured to evaluate the at least one user characteristic in view of the at least one machine-user rule to determine when the at least one user characteristic meets the first threshold and to generate a machine command for the work machine when the at least one user characteristic meets the first threshold.

In another aspect the disclosure provides a method for operating a work machine. The method includes collecting user characteristic data with at least one user characteristic from a portable device associated with a user; evaluating the at least one user characteristic in view of a machine-user rule having a first threshold associated with the work machine to determine when the at least one user characteristic meets the first threshold; and generating a machine command for the work machine when the at least one user characteristic meets the first threshold.

The details of one or more embodiments are set forth in the accompanying drawings and the description below. Other features and advantages will become apparent from the description, the drawings, and the claims.

### BRIEF DESCRIPTION OF THE DRAWINGS

FIG. 1 is a schematic view of an environment with an example work machine in the form of a dump truck with which the disclosed machine-user protocol system and method may be associated;

FIG. 2 is a schematic block diagram illustrating an example machine-user protocol system; and

FIG. 3 is a flowchart illustrating an example machine-user protocol method of the disclosed system of FIG. 2 in accordance with one of various embodiments.

Like reference symbols in the various drawings indicate like elements.

### DETAILED DESCRIPTION

The following describes one or more example embodiments of the disclosed system and method, as shown in the accompanying figures of the drawings described briefly above. Various modifications to the example embodiments may be contemplated by one of skill in the art.

As used herein, unless otherwise limited or modified, lists with elements that are separated by conjunctive terms (e.g., “and”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C).

As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of work machines.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

The following describes one or more example implementations of the disclosed machine-user protocol systems and methods for operating a work machine, as shown in the accompanying figures of the drawings described briefly above. Generally, the disclosed systems and methods (and work machines in which they may be implemented) provide for improved safety as compared to conventional systems by requiring the monitoring of user characteristics and generating machine commands based on the user characteristics, such as actuating a brake assembly (e.g., any type of braking mechanism) or disabling operation of a work machine when the user is too close to the machine or when an incapacitated user is attempting to operate the work machine. This ensures that the machine is operated in a safe and efficient manner.

Discussion herein may sometimes focus on the example application of a machine-user protocol system associated with an articulated dump truck. In other applications, other configurations are also possible. For example, work machines in some embodiments may be configured as haulers or loaders, graders, or similar machines. Further, work machines may be configured as machines other than construction machines, including machines from the agriculture, forestry and mining industries, such as tractors, combines, harvesters, yarders, skylines, feller bunchers, and so on. Thus, the configuration of the monitoring system for use with an articulated dump truck is merely an example.

Generally, the disclosed machine-user protocol system receives data representing user characteristics collected by a portable device, such as a wearable device worn by the user. In one example, the user characteristics include user location information and/or other physical characteristics or biometrics information collected by the wearable device. The machine-user protocol system may also receive and process machine characteristic data associated with the work machine. In some examples, upon receipt of the user characteristic data, the machine-user protocol system determines a user type that represents the relationship of the user to the work machine. For example, the user type may represent that the user is the operator of the work machine, and/or the user type may represent that the user is a non-operator of the work machine that is otherwise in the vicinity of the work machine. In some examples, upon receipt of the machine characteristic data, the machine-user protocol system may determine a machine state. Machine states may be, as examples, inactive, idle, operating, and/or imminent operation. Based on the user type and machine states, the machine-user protocol system may evaluate the user characteristics based on one or more machine-user rules that represent safe operation of the machine relative to the user. When a user characteristic exceeds a threshold defined by the machine-user rules, the machine-user protocol system generates a suitable command for the work machine. For example, if the user is a non-operator and the work machine is operating, and the associated machine-user rules indicate that the user should maintain a distance of at least 10 feet from the machine, but the user characteristics indicate that the user is within this radius, the machine-user protocol system generates a stop command for the work machine to cease operation. Further, if the user is an operator and the work machine is operating, and the associated machine-user rules indicate that the user operator must have a predetermined amount of activity, but the user characteristics indicate that the user is inactive or otherwise incapacitated, the machine-user protocol system generates a stop command for the work machine to cease operation.

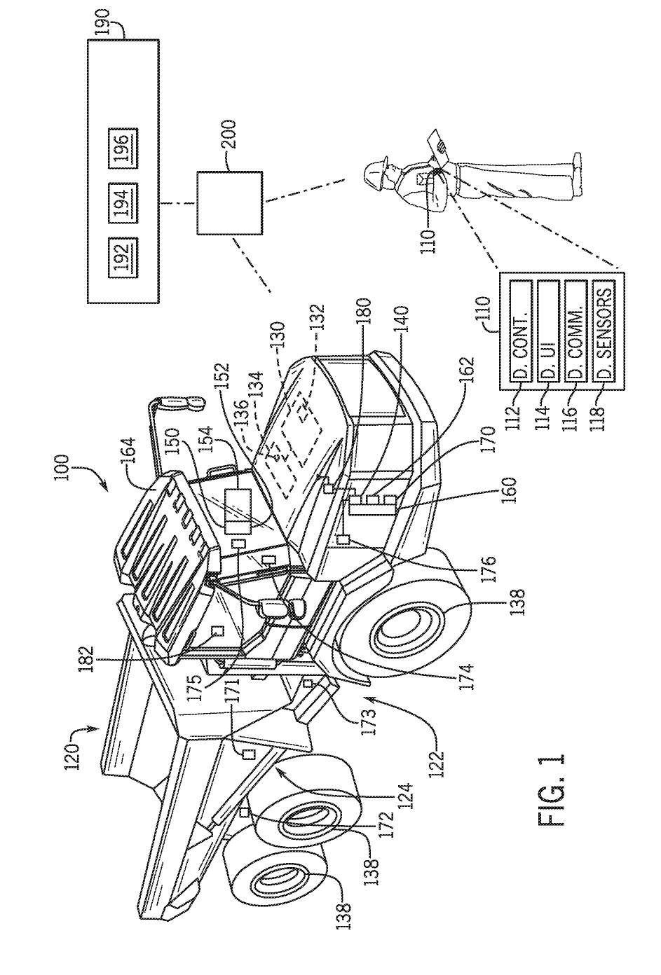

As noted above and now referring to FIG. 1, a mobile machine-user protocol system 200 may be utilized with regard to various mobile work vehicles 100 and other types of mobile machines, including the depicted articulated dump truck of FIG. 1. The machine-user protocol system 200 may further be used in conjunction with a portable device 110 associated with a user, and in some instances with a remote station or center 190. In one example, the portable device is a wearable device 110 worn by the user. As used herein, the “user” typically refers to the wearer of the wearable device 110 subject to the monitoring and associated protocol rules, although other contexts or usages may be referenced below, as appropriate. In one embodiment, the user with the wearable device 110 is a person within the environment of the work machine 100 as the work machine 100 operates, e.g., a worker or visitor at a job site. In other embodiments, the user may also be an operator of the work machine 100.

As described in greater detail below, the machine-user protocol system 200 may interact with one or more of the work machine 100, wearable device 110, and remote center 190 to monitor the user and facilitate operation of the work machine 100. In various embodiments, the machine-user protocol system 200 may be incorporated into one of the work machine 100, wearable device 110, or remote center 190; into more than one of the work machine 100, wearable device 110, or remote center 190 (e.g., as a distributed system); or as a stand-alone system. The work machine 100, wearable device 110, and remote center 190 will be described below prior to a more detailed discussion of the machine-user protocol system 200.

In one example, the work machine 100 includes a work tool, such as a load bin 120, mounted to a machine frame 122. It will be understood that the configuration of the work machine 100 having a work tool as the load bin 120 is presented as an example only. The load bin 120 defines a receptacle to receive a payload. One or more hydraulic cylinders 124 are mounted to the frame 122 and the load bin 120, such that the hydraulic cylinders 124 may be driven or actuated in order to pivot the load bin 120 about a pivot point.

The work machine 100 includes a source of propulsion, such as an engine 130 that supplies power to a transmission 134. In one example, the engine 130 is an internal combustion engine, such as a diesel engine, that is controlled by an engine control module 132. The engine control module 132 may receive one or more control signals or control commands from a controller 140 to enable start-up of the engine 130, enable shutdown of the engine 130, and/or disable operation of the engine 130, for example, based on input received from a human-machine interface 150, as well as based on commands from the machine-user protocol system 200. It should be noted that the use of an internal combustion engine is merely an example, as the propulsion device can be a fuel cell, an electric motor, a hybrid-gas electric motor, etc.

The transmission 134 transfers the power from the engine 130 to a suitable driveline coupled to one or more driven wheels 138 of the work machine 100 to enable the work machine 100 to move. As is known to one skilled in the art, the transmission 134 may include a suitable gear transmission operated in a variety of ranges containing one or more gears, including, but not limited to a park range, a neutral range, a reverse range, a drive range, a low range, etc. In one example, the transmission 134 is controlled by a transmission control module 136. The transmission control module 136 receives one or more control signals or control commands from the controller 140 to enable or disable motion of the work machine 100, for example, based on input received from the human-machine interface 150, as well as based on commands from the machine-user protocol system 200.

The work machine 100 also includes one or more pumps 160, which may be driven by the engine 130 of the work machine 100. Flow from the pumps 160 may be routed through various control valves 162 and various conduits in order to drive the hydraulic cylinders 124. Flow from the pumps 160 may also power various other components of the work machine 100. The flow from the pumps 160 may be controlled in various ways (e.g., through control of the various control valves 162) according to commands from the controller 140 in order to cause movement of the hydraulic cylinders 124, and thus, movement of the load bin 120 (and/or other work tools) relative to the machine frame 122, for example, based on input received from the human-machine interface 150, as well as based on commands from the machine-user protocol system 200. Although not shown in detail, other aspects of the work machine 100 may be controlled with individual motors and the like with commands from the controller 140 based on input from the human-machine interface 150 and/or machine-user protocol system 200.

The work machine 100 may also include one or more brake assemblies 182 that, upon actuation, stop one or more operational aspects of the work machine 100. As examples, the brake assemblies 182 may include a propulsion brake to stop movement of the overall work machine 100 and/or a tool brake to stop movement of the work tool, e.g., the load bin 120. The brake assemblies 182 may be actuated by a command from the controller 140, for example, based on input received from the human-machine interface 150, as well as based on commands from the machine-user protocol system 200. In one example, the brake assemblies 182 may be actuated by a stop command from the machine-user protocol system 200. As a result, in this context, the stop command may stop movement or operation of any system or component associated with the work machine 100, including the engine 130, transmission 134, or wheels 138 (e.g., to stop movement of the overall work machine 100), as well as the pumps 160 and/or control valves 162 (e.g., to stop movement of the work tool, such as the load bin 120).

Generally, the controller 140 (or multiple controllers) may be provided, for control of various aspects of the operation of the work machine 100. The controller 140 (or others) may be configured as a computing device with associated processor devices and memory architectures, as a hard-wired computing circuit (or circuits), as a programmable circuit, as a hydraulic, electrical or electro-hydraulic controller, or otherwise. As such, the controller 140 may be configured to execute various computational and control functionality with respect to the work machine 100 (or other machinery). In some embodiments, the controller 140 may be configured to receive input signals in various formats (e.g., as hydraulic signals, voltage signals, current signals, and so on), and to output command signals in various formats (e.g., as hydraulic signals, voltage signals, current signals, mechanical movements, and so on). In some embodiments, the controller 140 (or a portion thereof) may be configured as an assembly of hydraulic components (e.g., valves, flow lines, pistons and cylinders, and so on), such that control of various devices (e.g., pumps or motors) may be effected with, and based upon, hydraulic, mechanical, or other signals and movements.

The controller 140 may be in electronic, hydraulic, mechanical, or other communication with various other systems or devices of the work machine 100 (or other machinery). For example, the controller 140 may be in electronic or hydraulic communication with various actuators, sensors, and other devices within (or outside of) the work machine 100, including various devices associated with the pumps 160, control valves 162, and so on. The controller 140 may communicate with other systems or devices (including other controllers) in various known ways, including via a CAN bus (not shown) of the work machine 100, via wireless or hydraulic communication means, or otherwise. An example location for the controller 140 is depicted in FIG. 1. It will be understood, however, that other locations are possible including other locations on the work machine 100, or various remote locations.

In some embodiments, the controller 140 may be configured to receive input commands and to interface with an operator via the human-machine interface 150, which may be disposed inside a cab 164 of the work machine 100 for easy access by the operator. The human-machine interface 150 may be configured in a variety of ways. In some embodiments, the human-machine interface 150 may include an input device 152 with one or more joysticks, various switches or levers, one or more buttons, a touchscreen interface that may be overlaid on a display 154, a keyboard, a speaker, a microphone associated with a speech recognition system, or various other human-machine interface devices. The human-machine interface 150 also includes the display 154, which can be implemented as a flat panel display or other display type that is integrated with an instrument panel or console of the work machine 100. Those skilled in the art may realize other techniques to implement the display 154 in the work machine 100. The display 154 may include any suitable technology for displaying information, including, but not limited to, a liquid crystal display (LCD), organic light emitting diode (OLED), plasma, or a cathode ray tube (CRT).

Various sensors may also be provided to observe various conditions associated with the work machine 100. In some embodiments, various sensors 170 (e.g., pressure, flow or other sensors) may be disposed near the pumps 160 and control valves 162, or elsewhere on the work machine 100. For example, sensors 170 may include one or more pressure sensors that observe a pressure within the hydraulic circuit, such as a pressure associated with at least one of the one or more hydraulic cylinders 124 and/or the pumps 160. In some embodiments, various sensors 171 may be disposed on or near the load bin 120 in order to measure parameters associated with including the load or the load bin 120. Various sensors 172 may also be disposed on or near the frame 122 in order to measure parameters, such as an incline or slope of the machine 100, and so on. In addition, various sensors 173 are disposed on or near the frame 122 in order to observe an orientation of the load bin 120 relative to the frame 122. In further examples, a seat sensor 174 may be provided to determine the presence or absence of an operator in the cab 164. Additionally, the work machine 100 may include one or more location sensors 175, such as GPS receivers or inertial measurement units, that provide signals to the controller 140 to ascertain the location of the work machine 100. The work machine 100 may also include a clock 176 that provides a time of day and a date. Each of the sensors 170-176 may be in communication with the controller 140 via a suitable communication architecture, such as the CAN bus associated with the work machine 100.

The work machine 100 further includes a machine communication component 180. The machine communication component 180 enables communication between the controller 140 and the wearable device 110, remote center 190, and/or machine-user protocol system 200. The machine communication component 180 comprises any suitable system for receiving data from and transmitting data to wearable device 110, remote center 190, and/or machine-user protocol system 200. For example, the machine communication component 180 may include a radio or suitable receiver configured to receive data transmitted by modulating a radio frequency (RF) signal via a cellular telephone network according to the long-term evolution (LTE) standard. However, other techniques for transmitting and receiving data may alternately be utilized. In one example, the machine communication component 180 achieves bi-directional communications with the wearable device 110, remote center 190, and/or machine-user protocol system 200 over Bluetooth®, satellite or by utilizing a Wi-Fi standard, i.e., one or more of the 802.11 standards as defined by the Institute of Electrical and Electronics Engineers (“IEEE”), as is well known to those skilled in the art. Thus, the machine communication component 180 may include a Bluetooth® transceiver, a satellite transceiver, a radio transceiver, a cellular transceiver, an LTE transceiver and/or a Wi-Fi transceiver. The machine communication component 180 may employ various security protocols and techniques to ensure that appropriately secure communication takes place between the work machine 100 and the wearable device 110, remote center 190, and/or machine-user protocol system 200.

As described in greater detail below, the controller 140 collects various data associated with the work machine 100 as machine characteristic data to be evaluated by the machine-user protocol system 200. The machine characteristic data may be in the form of raw data from the applicable sensors 170-176 (or other sources) or undergo some processing in the controller 140 in order to extract the desired characteristics. Further, the controller 140 may receive and implement commands from the machine-user protocol system 200, e.g. a stop command to stop operation of the work machine 100 and/or bin 120. Further details will be provided below.

Generally, the wearable device 110 is a personal device worn or carried by the user. In one exemplary embodiment, the wearable device 110 is a watch, “smart watch”, or “body monitor” that is attached or mounted on the wrist of the user, such an Apple or Android watch. Although not shown in detail, the wearable device 110 may include a case body that at least partially houses the hardware and software components of the wearable device 110. The case body may be attached to a strap with a buckle for securing the wearable device 110 to the arm of the user such that a front surface of the wearable device is visible and a rear surface contacts the wrist of the user. In some examples, the wearable device 110 may include or be paired with one or more further portable electronic devices, such as a tablet computing device, mobile or smart cellular phone, personal digital assistant, a laptop computing device, etc. Although not specifically described, the wearable device 110 may include a number of additional components that are common to watches and mobile devices. Moreover, in some exemplary embodiments, the wearable device 110 may have other forms, such as being incorporated or integrated into clothing, helmets, glasses, chest straps, and the like.

In one example, the wearable device 110 includes a device controller 112, a device user interface 114, a device communication component 116, and various sensors 118. The device controller 112 may be configured as a computing device with associated processor devices and memory architectures, as a hard-wired computing circuit (or circuits), as a programmable circuit, or otherwise. The device controller 112 is in communication with the device user interface 114, the device communication component 116, and sensors 118 over a suitable interconnection architecture or arrangement that facilitates transfer of data, commands, power, etc. In some examples, the device controller 112 may store a unique identifier associated with the wearable device 110 and/or user. The identifier may be used to identify the wearable device 110 and/or user to other systems (e.g., work machine 100, remote center 190, and/or machine-user protocol system 200).

The device user interface 114 allows the user of the wearable device 110 to interface with the wearable device 110 (e.g. to input commands and data). In one example, the device user interface 114 includes an input device and a display, e.g., on the front face of the device 110. The input device is any suitable device capable of receiving user input, including, but not limited to, a keyboard, a microphone, a touchscreen layer associated with the display, or other suitable device to receive data and/or commands from the user. Multiple input devices can also be utilized. The display comprises any suitable technology for displaying information, including, but not limited to, a liquid crystal display (LCD), light emitting diode (LED), organic light emitting diode (OLED), plasma, or a cathode ray tube (CRT). In some embodiments, the device user interface 114 may include haptic actuators to provide a tactile signal to the user.

The device communication component 116 comprises any suitable system for receiving data from and transmitting data to the work machine 100, remote center 190, and machine-user protocol system 200. For example, the device communication component 116 may include a radio or suitable receiver configured to receive data transmitted by modulating a radio frequency (RF) signal via a cellular telephone network according to the long-term evolution (LTE) standard, although other techniques may be used. For example, the device communication component 116 may achieve bi-directional communications with the work machine 100, remote center 190, and/or machine-user protocol system 200 over Bluetooth® or by utilizing a Wi-Fi standard, i.e., one or more of the 802.11 standards as defined by the Institute of Electrical and Electronics Engineers (“IEEE”), as is well known to those skilled in the art. Thus, the device communication component 116 may include a Bluetooth® transceiver, a radio transceiver, a cellular transceiver, an LTE transceiver and/or a Wi-Fi transceiver. The device communication component 116 may employ various security protocols and techniques to ensure that appropriately secure communication takes place between the wearable device 110 and the work machine 100, remote center 190, and/or machine-user protocol system 200.

The device sensors 118 are coupled to the device controller 112 and generally represent the collection of sensors within the wearable device 110 that function to collect data associated with the position and motion of the wearable device 110, and thus, the user. The sensors 118 may include, as examples, GPS receivers, accelerometers and position sensors to determine the position, movement, and orientation of the wearable device. 110. The sensors 118 may further include one or more types of biometric sensors, such as heart rate monitors, sweat monitors, and oxygen level monitors. For example, sensors 118 may utilize electrodes and/or infrared light mechanisms to measure heart rate or oxygen levels in the blood. Other types of characteristics measured by the sensors 118 may include body temperature, brain activity, muscle motion, and the like.

As described below, the wearable device 110 is generally configured to collect information associated with the user as user characteristic data for consideration by the machine-user protocol system 200. In some examples, the wearable device 110 may transmit the user characteristic data to the machine-user protocol system 200, including position information, biometric information, and/or identifying information. The user characteristic data may be provided to the machine-user protocol system 200 in any form, including raw data from the sensors 118 and/or data processed by the wearable device 110 to extract the relevant characteristics. The user characteristic data may be broadcast continuously, upon establishing a communication links with the machine-user protocol system 200, or when the wearable device 110 is in the proximity of the work machine 100. In some embodiments, the wearable device 110 may also be configured to provide the user with notifications from the machine-user protocol system 200.

As introduced above, the machine-user protocol system 200 may further cooperate with the remote center 190, or in some embodiments, be implemented in the remote center 190. Alternatively, the remote center 190 may be omitted. The remote center 190 includes a remote communication component 192, a remote controller 194, and one or more remote data stores 196. The remote communication component 192 comprises any suitable system for receiving data from and transmitting data to the work machine 100, wearable device 110, and machine-user protocol system 200. For example, the remote communication component 192 may include a radio or suitable receiver configured to receive data transmitted by modulating a radio frequency (RF) signal via a cellular telephone network transmitted according to the long-term evolution (LTE) standard. However, other techniques for transmitting and receiving data may alternately be utilized. For example, the remote communication component 192 may achieve bi-directional communications with the work machine 100, wearable device 110, and machine-user protocol system 200 over Bluetooth®, satellite, or by utilizing a Wi-Fi standard, i.e., one or more of the 802.11 standards as defined by the Institute of Electrical and Electronics Engineers (“IEEE”), as is known to those skilled in the art. Thus, the remote communication component 192 comprises a Bluetooth® transceiver, a radio transceiver, a cellular transceiver, a satellite transceiver, an LTE transceiver and/or a Wi-Fi transceiver. The remote communication component 192 may employ various security protocols and techniques to ensure that appropriately secure communication takes place between remote center 190 and the work machine 100, the wearable device 110, and/or machine-user protocol system 200. In one example, the remote center 190 may include or otherwise cooperate with the JDLink™ system commercially available from Deere & Company of Moline, Ill.

The remote controller 194 is in communication with the remote communication component 192 and the one or more remote data stores 196 over a suitable interconnection architecture or arrangement that facilitates transfer of data, commands, power, etc. The remote controller 194 may also be in communication with one or more remote users via a portal, such as a web-based portal. The remote controller 194 may be configured as a computing device with associated processor devices and memory architectures, as a hard-wired computing circuit (or circuits), as a programmable circuit, or otherwise.

As noted above, in one embodiment, the remote center 190 may implement one or more aspect of the machine-user protocol system 200 described below, including providing requested or desired data for carrying out the associated functions. In further embodiments, the remote center 190 receives and stores data from the work machine 100, wearable device 110, and machine-user protocol system 200, as well as from similar machines, devices, and systems from across a fleet or workforce.

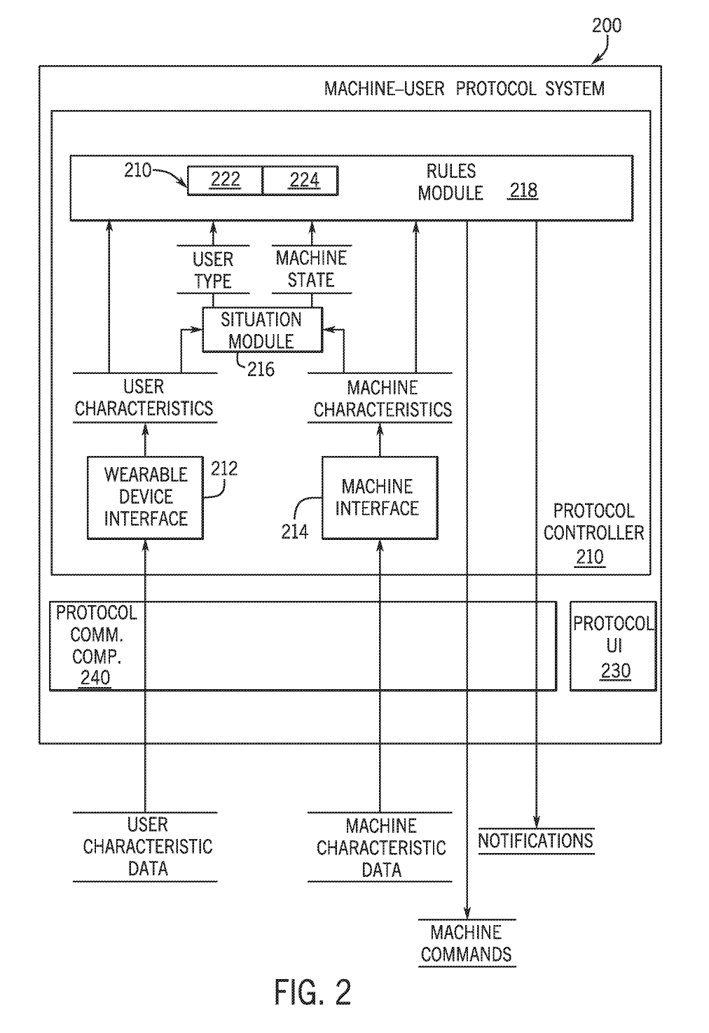

FIG. 2 is a schematic block diagram with dataflows that illustrates various aspects of the machine-user protocol system 200 associated with the work machine 100, wearable device 110, and/or remote center 190. As noted above, functions of the machine-user protocol system 200 may be embedded within the respective controller 140, 112, 194 of one or more of the work machine 100, wearable device 110, and/or remote center 190 and utilize respective components of those systems (e.g., interface 150, 114; communication component 180, 116, 192). In some embodiments, particular functions may be performed on the work machine 100, while other functions may be performed on the wearable device 110 and/or the remote center 190. In further embodiments, the machine-user protocol system 200 may be implemented as a stand-alone device or system. In one embodiment, the machine-user protocol system 200 may be considered to include the wearable device 110.

In one example, the machine-user protocol system 200 includes protocol controller 210, protocol user interface 230, and protocol communication component 240. Generally, the controller 210 may be provided to control various aspects of the operation of the machine-user protocol system 200. The controller 210 may be configured as a computing device with associated processor devices and memory architectures, as a hard-wired computing circuit, as a programmable circuit, as a hydraulic, electrical or electro-hydraulic controller, or otherwise. As such, the controller 210 may be configured to execute various computational and control functionality with respect to the machine-user protocol system 200, e.g., as programs stored in memory. As described in greater detail below, the controller 210 may particularly be configured to implement one or more functional units or modules, including a wearable device interface module 212, a work machine interface module 214, a situation module 216 and a rules module 218.

The protocol user interface 230 allows an operator of the machine-user protocol system 200 to interface with the machine-user protocol system 200 (e.g. to input commands and data and receive data). In this context, the operator of the machine-user protocol system 200 may be a user wearing the wearable device 110, the operator of the work machine 100, or another person operating the machine-user protocol system 200 as a stand-alone system.

In one example, the protocol user interface 230 includes an input device and a display. The input device is any suitable device capable of receiving input, including, but not limited to, a keyboard, a microphone, a touchscreen layer associated with the display, or other suitable device to receive data and/or commands. Of course, multiple input devices can also be utilized. The display comprises any suitable technology for displaying information, including, but not limited to, a liquid crystal display (LCD), light emitting diode (LED), organic light emitting diode (OLED), plasma, or a cathode ray tube (CRT).

The protocol communication component 240 enables communication between the protocol controller 210 and the work machine 100, wearable device 110, and/or remote center 190. The protocol communication component 240 comprises any suitable system for receiving data from and transmitting data to work machine 100, wearable device 110, and/or remote center 190. For example, the protocol communication component 240 may include a radio or suitable receiver configured to receive data transmitted by modulating a radio frequency (RF) signal via a cellular telephone network and the data may be transmitted according to the long-term evolution (LTE) standard. In one example, the protocol communication component 240 achieves bi-directional communications with the work machine 100, wearable device 110, and/or remote center 190 over Bluetooth®, satellite or by utilizing a Wi-Fi standard, i.e., one or more of the 802.11 standards as defined by the Institute of Electrical and Electronics Engineers (“IEEE”), as is well known to those skilled in the art. Thus, the protocol communication component 240 comprises a Bluetooth® transceiver, a satellite transceiver, a radio transceiver, a cellular transceiver, an LTE transceiver and/or a Wi-Fi transceiver. The protocol communication component 240 may employ various security protocols and techniques to ensure that appropriately secure communication takes place between the machine-user protocol system 200 and the work machine 100, wearable device 110, and/or remote center 190.

Now that the components of the machine-user protocol system 200 have been briefly described, a more detailed description of the functional units or modules 212, 214, 216, 218 implemented by the protocol controller 210 will be provided. As can be appreciated, the modules shown in FIG. 2 may be combined and/or further partitioned to similarly operate according to the functions described herein.

Generally, the wearable device interface module 212 functions to collect information associated with the user being monitoring with the assistance of the wearable device 110. In particular, the wearable device interface module 212 may receive the user characteristic data from the wearable device 110 and extract one or more user characteristics. As noted above, the user characteristics may include location information, biometric information, and identifying information. The location information may represent the location of the user as absolute coordinates or relative to a reference point, such as relative to the work machine 100. The location information may further include derivatives of location, such as direction, velocity, and acceleration of user movement. The biometric information may include information regarding user activity (e.g., the frequency and nature of the physical movement of the user), user heart rate, user sweat rate, oxygen levels, and the like. The identifying information may correspond to a unique identifier of the wearable device 110, and thus the user. The user characteristics may be based on data collected by the sensors 118 of the wearable device 110 and transmitted by the device communication component 116 to the protocol communication component 240 for evaluation by the protocol controller 210. In some examples, such as when the machine-user protocol system 200 is implemented on the wearable device 110, the user characteristics may be received directly from the sensors 118 and/or the wearable device controller 112.

Generally, the machine interface module 214 functions to collect information associated with the machine. In particular, the machine interface module 214 receives the machine characteristic data from the machine 100 and extracts one or more machine characteristics. As noted above, the machine characteristics may include location information and operating information. The location information may represent the location of the machine as absolute coordinates or relative to a reference point, such as relative to the user. The location information may further include derivatives of location, such as direction, velocity, and acceleration of machine movement. The operating information may include information regarding the operation of the machine, such as the engine parameters, transmission parameters, machine control status, operator status, etc. The user characteristics may be based on data collected by the sensors 170-176 of the work machine 100 and transmitted by the machine communication component 180 to the protocol communication component 240 for evaluation by the protocol controller 210. In some examples, such as when the machine-user protocol system 200 is implemented on the work machine 100, the user characteristics may be received directly from the sensors 170-176 and/or the machine controller 140.

The situation module 216 receives the user characteristics and the machine characteristics. Generally, the situation module 216 functions to determine the type of the user and the state of the machine. The situation module 216 may include algorithms or models in which the various characteristics are evaluated to determine the type or state. As noted above, in one example, the “type” of user may represent the relationship of the user to the work machine 100. For example, the user may be an operator of the work machine 100 or a non-operator in the environment of the work machine 100. In one embodiment, the type of the user may be determined by the location information associated with the user characteristics, e.g., whether or not the user is inside the cab 164 as an operator or outside of the cab 164 as a non-operator. In a further example, the user type may be based on the identifying information that associates the particular user with the respective work machine 100. As also noted above, in one example, the state of work machine may be determined as inactive, idle, operating, or imminent operation. Generally, the machine state may provide some indication of the overall risk to any user in the work site, as discussed in greater detail below. In one embodiment, the state of the work machine may be determined by the engine or control parameters, the presence or absence of an operator in the cab 164, whether or not the engine 130 is active, and/or a clock (e.g., working hours). In some embodiments, the situation module 216 may be omitted and/or one or more of the machine state and/or user type may be considered to have a single state or type.

The situation module 216 provides the user type and the machine state to the rules module 218. The rules module 218 includes a set of rules 220 (e.g., embodied as a model, table, or algorithm) selected based on the user type and machine state. The rules 220 are generally selected or constructed to facilitate safe and efficient operation of the work machine 100 relative to the user. The rules 220 may represent scenarios or situations in which machine operation may be modified based on one or more user characteristics. Such situations may be defined with triggers or other thresholds that, when met, result in machine commands and/or other consequences, as described below. The rules 220 may have any applicable format, such as “for [machine state_n] and [user type_n], if [user characteristic_n]>[rules threshold_n], then [command_n] and [notification_n].” Further details about the rules 220, including examples, are provided below.

The rules 220 may be selected based on conditions in which human physical interactions with the work machine 100 have the potential to create undesirable situations. In other words, each rule 220 represents an action, behavior, or condition of the user that is inappropriate for the machine state. The rules 220 may be based on limitations or guidelines required by regulation and/or corporate policy for safe operation of the machine 100.

As such, the rules 220 may be directed to various scenarios and may be dependent on the user type and/or machine state. For example, when the machine state is inactive, the risk to the user may be remote and less restrictive (or no) rules may be applicable, as compared to when the machine state is operating. Similarly, the applicable rules may be different when the user type is an operator or a non-operator. Some additional examples are discussed below.

As one example, when the user is an operator of the work machine 100, the rules 220 may be directed to ensuring that the user is physically and/or mentally capable of operating the work machine 100. Such rules 220 for the user as the operator may be considered “capacity” rules 222. Any suitable capacity rules 222 may be implemented. For example, the capacity rules 222 may be associated with user attentiveness, e.g., indicating that the user is awake and/or alert, and include thresholds associated with heart rate or user activity. The capacity rules 222 may be formed based on empirical data that link physical or physiological attributes with attentiveness or performance measures in order to identify suitable user characteristics and appropriate thresholds.

As another example, when the user is not an operator of the work machine 100, the rules 220 may be directed to ensuring that the user maintains a safe distance from the work machine 100. Such rules 220 for the user may be considered “safety” rules 224. Any suitable safety rules 224 may be implemented. For example, the safety rules 224 may be associated with a predetermined distance between the user and the work machine 100, and include thresholds associated with relative locations of the work machine 100 and user. The distance thresholds may be fixed (e.g., a predetermined number of feet), or the distance thresholds may be a function of various machine and/or user characteristics, such as the speed of the user or machine, the size of the machine, etc. In some instances, the user may be an operator and still subject to safety rules 224, such as would be case for a user that controls some aspect of the work machine 100 from outside of a protected area, such as the cab 164. More specific examples are provided below.

In one embodiment, as long as the user characteristics satisfy the applicable rules 220, the machine-user protocol system 200 may take no action. However, when the applicable user characteristic meets the respective threshold of one or more the rules 220, the rules module 218 generates an associated command. In some embodiments, the command may include a stop command that instructs the work machine 100 to stop one or more aspects of operation, such as engaging one or more brake assemblies 182 to stop propulsion of the work machine 100 or to stop tool operation of the work machine 100.

It should be noted that the user characteristics and/or machine characteristics may be continuously monitored such that the machine-user protocol system 200 evaluates such characteristics in view of changing circumstances. For example, the user characteristics may initially indicate that the user is an operator as the user type; however, the user characteristics may later indicate that the user is no longer an operator and may be outside of the work machine 100. In such cases, the user type will be modified to potentially provide different rules 220. Similarly, although a particular user is discussed in the examples, it should be appreciated that the machine-user protocol system 200 may be implemented with a number of users, each subject to particular rules based on the respective user characteristics, user type, and situation. Moreover, each user and associated wearable device 110 may be associated with machine-user protocol system (or systems) 200 for a number of work machines 100.

In some embodiments, the situation module 216 and rules module 218 may be combined into an overall model or algorithm for evaluating user characteristics based on the data provided by the wearable device 110 and work machine 100. The modules 216, 218 described above may be considered functional descriptions of such an overall model or algorithm. In some embodiments, one or more aspects of the modules 216, 218 may be omitted.

In some embodiments, the rules module 218 may further generate a confirmation request for the wearable device 110 prior to generating the machine command. The confirmation request may be displayed or otherwise communicated to the user via the wearable device 110. In response, the user may provide a confirmation response to the rules module 218 via the wearable device 110. In some instances, the rules module 218 may cancel or pause generation of the machine command in response to the confirmation response. If no confirmation response is received, the rules module 218 may generate the machine command as discussed above. In some cases, the rules module 218 may generate confirmation request based on the particular situation and/or user characteristics, e.g., generating the confirmation request when the user is approaching the work machine and foregoing the confirmation request when the user is very close to the work machine. As such, the confirmation response may be considered an “all clear” message to prevent unnecessary stop commands for the work machine 100. In other embodiments, this function may be omitted.

Upon generation of the command, the machine-user protocol system 200 provides the command to the work machine controller 140. In one embodiment, the protocol communication component 240 formats and sends the command to the machine communication component 180, which in turn provides the command to the machine controller 140 for implementation. In some instances, the machine controller 140 may send the command to the appropriate system control module, such as the engine control module 132. In this manner, the machine-user protocol system 200 functions to modify machine operation when the machine 100 poses a risk to the user.

In further embodiments, the machine-user protocol system 200 generates notifications for the wearable device 110 and the work machine 100 such that the user and/or operator of the work machine 100 may be informed of the situation. For example, the notification for the wearable device 110 may be in the form of a pop-up graphical element or text on the interface 114 of the wearable device 110 such that the user may view the information. In some instances, the notification on the wearable device 110 may give an indication of the user characteristic and/or situation that prompted the notification. For example, a notification on the wearable device 110 may state “Move Away from the Work Machine”. In other examples, the notification on the wearable device 110 may include a haptic or audible alert in the form of a “warning.” Corresponding notifications for the work machine 100 may be provided. For example, a notification for the work machine 100 may state “Operation Disabled; Person Too Close to Machine”. Other notifications for the work machine 100 may include an audible message broadcast over a speaker in the cab 164, a warning light disposed in the cab 164, and so on.

Accordingly, the machine-user protocol system 200 may implement control rules for various states and user characteristics in a number of situations. As noted above, in some embodiments, the machine-user protocol system 200 may implement proximity based safety rules 224 for a user relative to the work machine 100 or other aspect of the work site. For example, the safety rule 224 may define a restricted radius (e.g., 5 feet or 10 feet) relative to the work machine such that, if the user enters this restricted radius, a stop command for the work machine 100 is generated. In another example, the restricted area may be a geo-fence surrounding an active area of the work site such that, if the user enters this restricted radius, a stop command for the work machine 100 is generated. Example embodiments are particularly useful at work sites that may have obstructed views, such as heavy equipment and mining operations, as well as cable logging with yarders and skylines. In a forestry example, the safety rules 224 may define a restricted radius for users around work machines that function to winch cables to log bundles or to skylines. Such safety rules 224 are also particularly applicable for users in busy or crowded construction sites with material handlers, diggers, trucks, and hand assemblers working in close proximity.

Similarly, the capacity-based rules 222 may be applicable in a number of contexts. As noted above, the capacity rules 222 may define physiological attributes within the biometric user characteristics that indicate that the user should not be operating the work machine, thereby protecting the users, others at the work site, and the machine itself. Such embodiments may particularly be useful when the user and work machine are in remote locations, such as the case in many forestry or mining situations.

In some embodiments, the machine-user protocol system 200 may be used in conjunction with other monitoring or health systems. For example, some types of situations, such as forestry, may require regular check-in by the users in order to enable prompt assistance to accidents. In lieu of manual check-ins in these cases, the machine-user protocol system 200 may collect and evaluate user characteristics in view of machine-user rules 220, and in addition to generating stop commands for the work machine in the event of an incapacitation or accident, the machine-user protocol system 200 may provide a notification to a command center (e.g., remote center 190) requesting assistance for the user. In some embodiments, the system 200 may collect and evaluate user characteristics independently of user interaction with the work machine. For example, the system 200 may be implemented to monitor user characteristics in view of work requirements such as check-in requirements, location requirements, and/or activity requirements. If the biometric characteristics fail to comply with one or more of these requirements, the system 200 may send a notification to the user via the wearable device 110 requiring a response. The user may indicate via the wearable device 110 that no assistance is necessary. Or, if the user indicates via the wearable device 110 that assistance is necessary or no response is received, the system 200 may request assistance for the user.

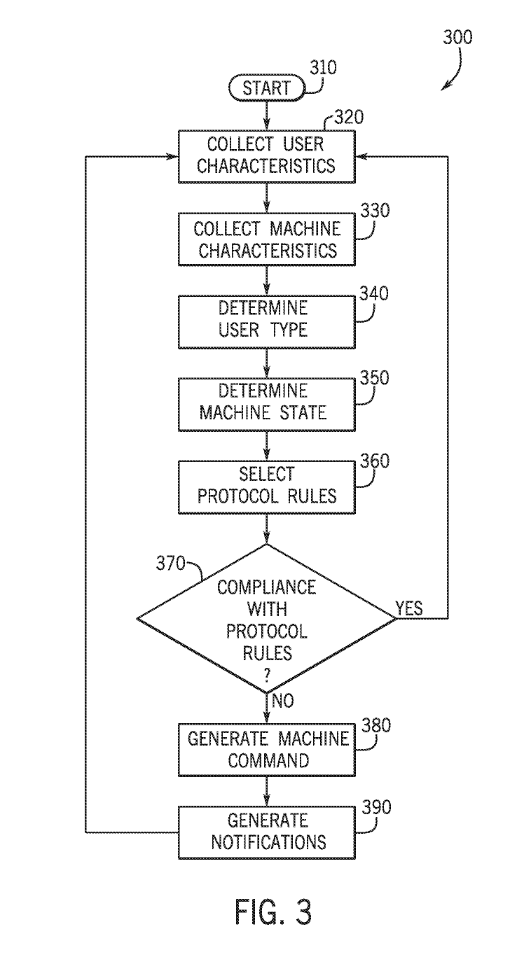

Referring now also to FIG. 3, as well with continuing reference to FIGS. 1 and 2, a flowchart illustrates a method 300 that may be performed by the machine-user protocol system 200 in accordance with the present disclosure. As can be appreciated in light of the disclosure, the order of operation within the method 300 is not limited to the sequential execution as illustrated in FIG. 3, but may be performed in one or more varying orders as applicable and in accordance with the present disclosure. Further one or more steps may be omitted and/or additional steps added.

In one example, the method 300 begins at step 310. The method 300 may be initiated in any suitable manner, including by user or operator initiation, according to time of day (e.g., during working hours), or upon occurrence of an event (e.g., starting of the work machine 100 or user movement).

In step 320, the machine-user protocol system 200 collects user characteristic data, e.g., from the wearable device 110. In step 330, the machine-user protocol system 200 collects machine characteristics data, e.g., from the work machine 100.

In step 340, the machine-user protocol system 200 determines the user type from the user characteristic data. In step 350, the machine-user protocol system 200 determines the machine state from the machine characteristic data.

In step 360, the machine-user protocol system 200 selects applicable machine-user rules based on the user type and machine state. In step 370, the machine-user protocol system 200 evaluates the user characteristics in view of the applicable machine-user rules. For example, one or more user characteristics may be compared to thresholds in the machine-user rules.

If the user characteristics comply with the machine-user rules (e.g., are within the thresholds), the method 300 returns to step 320. If the user characteristics do not comply with the machine-user rules (e.g., exceed one or more thresholds), the method 300 proceeds to step 380.

In step 380, the machine-user protocol system 200 generates a machine command associated with the relevant machine-user rule. The machine command may be, for example, a stop command to stop operation of the work machine 100 and/or any tool of the work machine 100. The machine command may be received and implemented by the controller 140 of the work machine 100. As noted above, the machine-user protocol system 200 may also send a confirmation request prior to generating the machine command and interrupt or cancel the machine command if a confirmation response is sent by the user and received by the system 200.

In step 390, the machine-user protocol system 200 further generates a notification associated with the relevant machine-user rule. The notification may provide information associated with the respective machine-user rule, user characteristic that failed to comply with the machine-user rule, and/or the machine command. Such notifications may be sent to the work machine 100 for consideration by the operator and to the wearable device 110 for consideration by the user.

Upon completion of step 380, the method 300 returns to step 320 for re-evaluation of the user type and machine state and user characteristics in order to determine if circumstances have changed such that operation of the work machine 100 may resume.

Accordingly, the embodiments discussed above provide improved machine-user protocol systems and methods for operating a work machine. In particular, embodiments enable the collection and evaluation of user characteristics in view of machine-user rules that define safe and unsafe situations relevant to the work machine. As such, exemplary embodiments improve safety and efficiency of a work site.

As will be appreciated by one skilled in the art, certain aspects of the disclosed subject matter can be embodied as a method, system (e.g., a work machine control system included in a work machine), or computer program product. Accordingly, certain embodiments can be implemented entirely as hardware, entirely as software (including firmware, resident software, micro-code, etc.) or as a combination of software and hardware (and other) aspects. Furthermore, certain embodiments can take the form of a computer program product on a computer-usable storage medium having computer-usable program code embodied in the medium.

Any suitable computer usable or computer readable medium can be utilized. The computer usable medium can be a computer readable signal medium or a computer readable storage medium. A computer-usable, or computer-readable, storage medium (including a storage device associated with a computing device or client electronic device) can be, for example, but is not limited to, an electronic, magnetic, optical, electromagnetic, infrared, or semiconductor system, apparatus, or device, or any suitable combination of the foregoing. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device. In the context of this document, a computer-usable, or computer-readable, storage medium can be any tangible medium that can contain, or store a program for use by or in connection with the instruction execution system, apparatus, or device.

A computer readable signal medium can include a propagated data signal with computer readable program code embodied therein, for example, in baseband or as part of a carrier wave. Such a propagated signal can take any of a variety of forms, including, but not limited to, electro-magnetic, optical, or any suitable combination thereof. A computer readable signal medium can be non-transitory and can be any computer readable medium that is not a computer readable storage medium and that can communicate, propagate, or transport a program for use by or in connection with an instruction execution system, apparatus, or device.

Aspects of certain embodiments are described herein can be described with reference to flowchart illustrations and/or block diagrams of methods, apparatus (systems) and computer program products according to embodiments of the invention. It will be understood that each block of any such flowchart illustrations and/or block diagrams, and combinations of blocks in such flowchart illustrations and/or block diagrams, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions can also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions can also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

Any flowchart and block diagrams in the figures, or similar discussion above, can illustrate the architecture, functionality, and operation of possible implementations of systems, methods and computer program products according to various embodiments of the present disclosure. In this regard, each block in the flowchart or block diagrams can represent a module, segment, or portion of code, which comprises one or more executable instructions for implementing the specified logical function(s). It should also be noted that, in some alternative implementations, the functions noted in the block (or otherwise described herein) can occur out of the order noted in the figures. For example, two blocks shown in succession (or two operations described in succession) can, in fact, be executed substantially concurrently, or the blocks (or operations) can sometimes be executed in the reverse order, depending upon the functionality involved. It will also be noted that each block of any block diagram and/or flowchart illustration, and combinations of blocks in any block diagrams and/or flowchart illustrations, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. Explicitly referenced embodiments herein were chosen and described in order to best explain the principles of the disclosure and their practical application, and to enable others of ordinary skill in the art to understand the disclosure and recognize many alternatives, modifications, and variations on the described example(s). Accordingly, various embodiments and implementations other than those explicitly described are within the scope of the following claims.

What is claimed is:

1. A mobile machine-user protocol system, comprising:
a communication component device configured to receive user characteristic data with at least one user characteristic collected by a portable device positioned on a user; and
a protocol controller coupled to the communication component device and storing at least one machine-user rule having a first threshold, the protocol controller comprising:
a portable device interface module configured to extract the at least one user characteristic from the user characteristic data; and
a rules module configured to evaluate the at least one user characteristic in view of the at least one machine-user rule to determine when the at least one user characteristic meets the first threshold and to generate a machine command for the work machine when the at least one user characteristic meets the first threshold.

2. The machine-user protocol system of claim 1, wherein the user characteristic is a user location and the first threshold is a predetermined distance from the work machine.

3. The machine-user protocol system of claim 1, wherein the user characteristic is biometric information and the first threshold is associated with user incapacity.

4. The machine-user protocol system of claim 3, wherein the biometric information is at least one of heart rate, sweat rate, and oxygen level.

5. The machine-user protocol system of claim 1, wherein the machine command is a stop command for the work machine.

6. The machine-user protocol system of claim 1, wherein the protocol controller is further configured to generate a notification for the portable device when the at least one user characteristic meets the first threshold.

7. The machine-user protocol system of claim 1, wherein the protocol controller is further configured to, prior to generating the machine command, generate a confirmation request for the portable device.

8. The machine-user protocol system of claim 1, wherein the protocol controller further comprises a situation module configured to determine a user type based on the user characteristic data, and wherein the rules module is configured to select the at least one machine-user rule based on the user type.

9. The machine-user protocol system of claim 8, wherein the user type includes at least one of the user as an operator of the work machine or the user as a person outside of the work machine.

10. The machine-user protocol system of claim 1, wherein the communication component device and the machine-user controller are implemented on the work machine.

11. The machine-user protocol system of claim 1, wherein the portable device is a wearable device; and
wherein the communication component device is configured to communicate with the wearable device wirelessly.

12. The protocol system of claim 1, further comprising the portable device, wherein the portable device includes at least one sensor that collects the user characteristic data from the user.

13. A method for operating a work machine, comprising:
collecting user characteristic data with at least one user characteristic from a portable device associated with a user;
evaluating the at least one user characteristic in view of a machine-user rule having a first threshold associated with the work machine to determine when the at least one user characteristic meets the first threshold; and
generating a machine command for the work machine when the at least one user characteristic meets the first threshold.

14. The method of claim 13,
wherein the collecting the user characteristic data includes determining a user location with at least one of a GPS receiver or an accelerometer on the portable device, and
wherein the evaluating includes determining a distance of the user from the work machine and comparing the distance to the first threshold.

15. The method of claim 13,
wherein the collecting the user characteristic data includes collecting user biometric information that includes at least one of heart rate, sweat rate, and oxygen level, and
wherein the evaluating step includes comparing the at least one of heart rate, sweat rate, or oxygen level to the first threshold.

16. The method of claim 13, wherein the generating step includes generating the machine command as a stop command for the work machine.

17. The method of claim 13, further comprising generating at least one of a first notification for the portable device or a second notification for the work machine when the at least one user characteristic meets the first threshold.

18. The method of claim 13, wherein the portable device is a wearable device; and wherein the collecting the user characteristic data includes communicating with the wearable device wirelessly.

19. The method of claim 13, further comprising transmitting the machine command to the work machine wirelessly for implementation on the work machine.

20. The method of claim 13, further comprising
determining a user type based on the on the user characteristic data, the user type including at least one of the user as an operator of the work machine or the user as a person outside of the work machine; and
selecting the machine-user rule based on the user type.
